(19) United States
(12) Patent Application Publication
(10) Pub. No.: US 2013/0116996 A1
(43) Pub. Date: May 9, 2013

(54) METHOD FOR INTEGRATING MODELS OF A VEHICLE HEALTH MANAGEMENT SYSTEM

(71) Applicant: Robert Edward Callan, Eastleigh (GB)

(72) Inventor: Robert Edward Callan, Eastleigh (GB)

(73) Assignee: GE AVIATION SYSTEMS LIMITED, Cheltenham (GB)

(21) Appl. No.: 13/362,666

(22) Filed: Jan. 31, 2012

(30) Foreign Application Priority Data
Nov. 8, 2011 (GB) 11192416

(51) Int. Cl. G06G 7/70

(52) U.S. Cl. 703/8

(57) ABSTRACT

A method for integrating the function models of a health management system for a vehicle where the vehicle has multiple systems connected to a communications network and the multiple systems send at least one of status messages and raw data regarding at least some of the operational data of the multiple systems and making a determination of a health function of the vehicle.

### CROSS-REFERENCE TO RELATED APPLICATIONS

This application claims priority under 35 U.S.C. §119 to British Patent Application No. 11192416, filed Nov. 8, 2011, the disclosure of which is incorporated herein by reference.

### BACKGROUND OF THE INVENTION

Contemporary vehicles including aircraft may include an Onboard Maintenance System (OMS) or a health monitoring or Integrated Vehicle Health Management (IVHM) system to assist in diagnosing or predicting (prognosing) faults in the vehicle. Such current health management systems may collect various vehicle data and analyze the data using health functions, which are health algorithms that have been implemented as executable software. The functions may be used to identify any irregularities or other signs of a fault or problem with the vehicle. Such systems are structured such that they naturally form layers, because the inputs of some health functions depend on the output of other health functions. All current systems currently lose access to complete data in the lower layers for use in the higher layers as many of the functions in lower layers merely pass on a result, not the data on which the result is based. It would be beneficial to implement the health functions without the loss of data from lower layers.

### BRIEF DESCRIPTION OF THE INVENTION

In one embodiment, a method for integrating function models of a health management system for a vehicle having multiple systems connected to a communications network and sending at least one of status messages and raw data regarding at least some operational data of the systems includes providing a plurality of health models, where each health model represents a health function of the vehicle, with at least some of the health models having parameters corresponding to at least some of the operation data, executing the health models to generate health data related to the corresponding health function, forming a database of the generated health data from the execution of the health models, forming a mixture model from the database for at least some of the health functions, generating a probabilistic graphical model (PGM) from the mixture model for the at least some of the health functions, and making a determination of a health function based on the generated PGM.

### BRIEF DESCRIPTION OF THE DRAWINGS

In the drawings:

FIG. 1 is a schematic illustration of an aircraft having a plurality of aircraft systems.

FIG. 2 is a schematic illustration of layering in a diagnostic system.

FIG. 3 is a schematic illustration of a PGM according to a first embodiment of the invention.

FIG. 4 is a schematic illustration of a PGM according to a second embodiment of the invention.

FIG. 5 is a schematic illustration of a PGM according to a third embodiment of the invention.

FIG. 6 is a schematic illustration of a PGM according to a fourth embodiment of the invention.

FIG. 7 is a schematic illustration of a PGM according to a fifth embodiment of the invention.

FIG. 8 is a schematic illustration of a PGM according to a sixth embodiment of the invention.

FIG. 9 is a schematic illustration of a PGM according to a seventh embodiment of the invention.

FIG. 10 is a schematic illustration of a PGM according to an eighth embodiment of the invention.

FIG. 11 is a schematic illustration of a PGM according to a ninth embodiment of the invention.

### DESCRIPTION OF EMBODIMENTS OF THE INVENTION

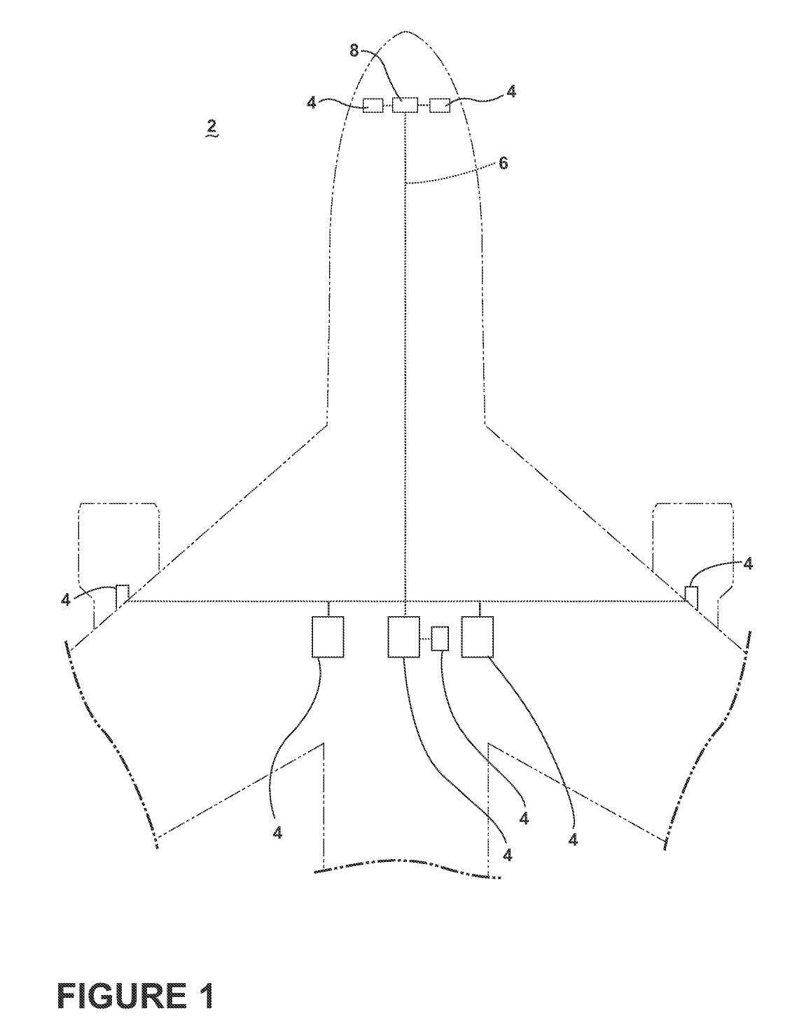

FIG. 1 schematically illustrates a portion of a vehicle in the form of an aircraft 2 having a plurality of aircraft member systems 4 that enable proper operation of the aircraft 2 and a communication system 6 over which the plurality of aircraft member systems 4 may communicate with each other and an aircraft health management (AHM) computer 8. It will be understood that the inventive concepts may be applied to any vehicle having multiple systems connected to a communications network and sending status messages and raw data regarding at least some operational data of the systems. The AHM computer 8 may include or be associated with, any suitable number of individual microprocessors, power supplies, storage devices, interface cards, and other standard components. The AHM computer 8 may receive inputs from any number of member systems or software programs responsible for managing the acquisition and storage of data. The AHM computer 8 is illustrated as being in communication with the plurality of aircraft systems 4 and it is contemplated that the AHM computer 8 may execute one or more health monitoring functions or be part of an Integrated Vehicle Health Management (IVHM) system to assist in diagnosing or predicting faults in the aircraft 2. During operation, the multiple aircraft systems 4 may send status messages regarding at least some of the operational data of the multiple aircraft systems 4 and the AHM computer 8 may make a determination of a health function of the aircraft 2 based on such data. During operation, analog inputs and analog outputs of the multiple aircraft systems 4 may be monitored by the AHM computer 8 and the AHM computer 8 may make a determination of a health function of the aircraft 2 based on such data.

Diagnostic and prognostic analytics apply knowledge to such data in order to extract information and value. For IVHM applications, there are a range of health functions, or just functions, required from data manipulation, state detection (e.g. anomaly detection), health reasoning, prognostics and decisioning. Each function requires a model that encodes knowledge of how to solve a task. An inference engine or algorithm then applies this model to new data to make predictions. Thus, the IVHM system will contain many different types of model associated with the different functions. As used herein the term “IVHM” refers to the collection of on-board and off-board functions required to manage the health of the vehicle. A major challenge for the IVHM system is how the model outputs should be integrated and how the outputs from different monitoring systems should be fused. If this is not done in a robust way, valuable information from lower level functions such as data manipulation and state detection will be lost when reasoning. Also, an approach which relies on a broad range of model types and functions complicates both the off-board and on-board integration architecture. An approach that may reduce complexity has value.

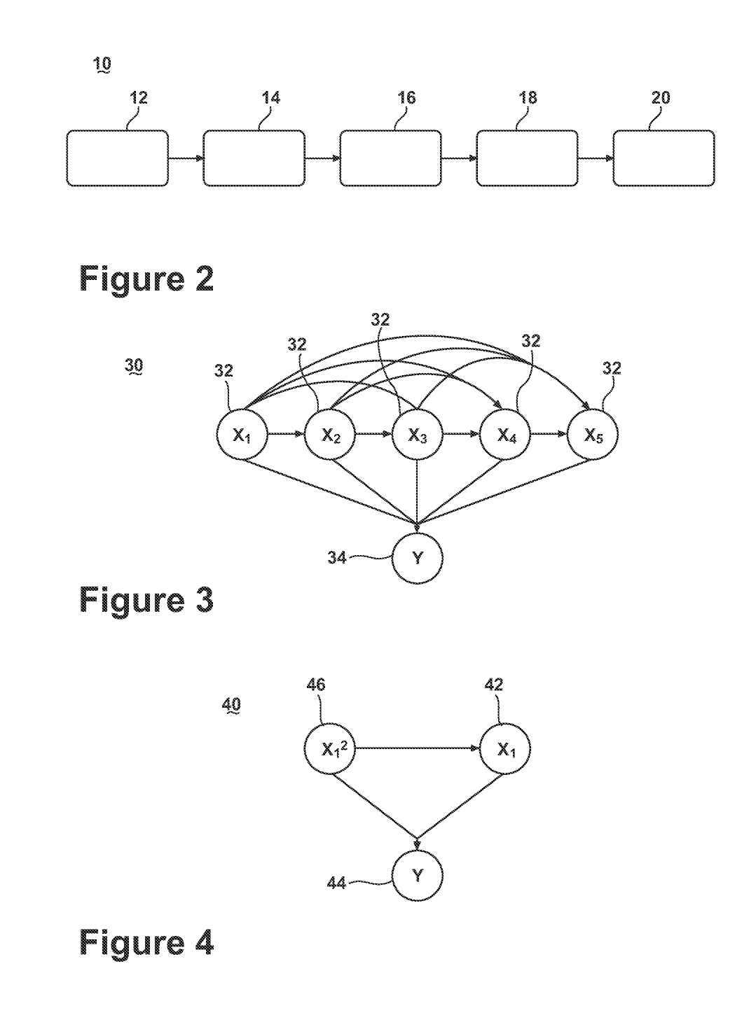

Any diagnostic or prognostic system may be conceptualized as having functions that reside within different layers. The layering implies an implicit ordering of function execution such that higher level functions derive higher level information. An example is the Open Systems Architecture for Condition-Based Maintenance (OSA-CBM) 10, which is schematically illustrated in FIG. 2. Each box in FIG. 2 is a layer containing one or more functions. An ordering from left to right shows that higher level layers have a dependency on lower level layers and that the level of information increases as the order increases (as layers move further to the right). Let j denote a layer and j+1 the layer to the right of j. For j+1 to have a higher level of information compared to j means that the outputs from j+1 have greater utility (or value) than the outputs from j. For example, if j is a state detection function that detects an abnormality and j+1 is a health assessment function that finds the root cause, most people would accept j+1 as having more value. Although there is an order to the functional layers there is no reason why a function could not request outputs from a function in a lower layer and communication could flow in both directions.

Data manipulation layer 12 performs tasks such as data correction and feature extraction. State detection layer 14 monitors the current state or behavior relative to an expected state. Functions such as threshold monitoring and anomaly detection fall in the state detection layer 14. A health assessment layer 16 performs diagnosis and troubleshooting. A prognostic assessment layer 18 predicts future health and how behavior could deteriorate. An advisory generation layer 20 assists with decision support and could involve simulation of what is likely to happen or could involve the selection of recommended actions based on likely outcome weighed by costs and benefits.

A specific example with respect to the OSA-CBM functional architecture 10 may proof useful and will be described with respect to performance analysis of a turbine engine. The data manipulation layer 12 performs data corrections relative to standard day conditions and the state detection layer 14 derives residual measurements by using a regression model to calculate the difference between a monitored parameter's actual measurement and predicted value then uses a multivariate state model to assess performance against expected healthy behavior. The health assessment layer 16 reasons about alerts on abnormal behavior and uses diagnostic knowledge of how the patterns in the residuals respond to faults. The prognostic assessment layer 18 predicts how any deterioration will progress over future flights and the advisory generation layer 20 uses a model of inspection/test/maintenance actions to optimize recommended actions. Any system on an aircraft could have its health management functions structured into these layers.

A fundamental weakness with existing health management systems is the integration of information from different functional layers and the fusion of information derived by different monitoring systems (such as vibration, lubrication monitoring, performance monitoring, etc.). For example, the output from a continuous distribution may be transformed to a binary value on the basis of whether some threshold is exceeded. Two individual monitored assets that differ in behavior by a small amount may be managed in very different ways because the output from state detection has been discretized in an inappropriate manner when communicating these outputs to health assessment. A further example is that two sub-systems outputs may be treated inappropriately as being completely independent. For example, foreign object damage to an engine could lead to increased vibration and performance deterioration and information about the response from one sub-system should inform the expectation of a response from the other sub-system. Both types of weakness may be viewed as an issue with model integration.

Embodiments of the invention use probabilistic graphical models (PGMs) as a framework for model integration for the IVHM and provide a method for learning a range of PGM models from historical data. Generally, PGMs use a graph-based representation as the foundation for encoding a complex distribution over a multi-dimensional space. The graph is a compact or factorized representation of a joint distribution. Examples of the type of model that can be represented by a PGM include: Bayesian networks, Markov models, Kalman filter, probabilistic treatment of Principal Component Analysis, Gaussian and discrete mixture models, In brief, a mixture model learning module is implemented that takes as inputs historical data, configuration parameters and a set of conditional discrete variables that essentially describes the model structure. The module then learns a collection of mixture models. Once learnt, these mixture models are integrated into a PGM structure. There are variations on the PGM structure depending on the nature of the inference task to which the PGM is to be applied.

A PGM framework may provide an appropriate method for integration of vehicle health management data and information without the loss of data from lower layers. A PGM represents a joint distribution over a set of random variables. In the context of vehicle health management variables may be measured parameters, failure modes/faults, diagnostic tests, observations or inspections, derived parameters, etc. A PGM consists of a set of random variables represented by nodes. A node may be a discrete variable described by a multinomial distribution or it may be a continuous variable described by a Gaussian density. Edges in the graph describe conditional relationships between variables. If a variable v1 has a link drawn from v1 to a variable v2, v1 is said to be a parent of v2 and v2 is said to be a child of v1. A continuous variable may have both discrete and continuous parents but a discrete variable may only have discrete parents. The distribution of a variable is conditioned on its parents.

The structure of a PGM refers to the definition of variables and the associations between variables. The parameters of a PGM refer to the probability distributions assigned to a variable which will be conditional distributions if a variable has one or more parent variables. The parameters may be based on subjective expert opinion or derived (or learnt) from historical data. Inference over a PGM follows the input of evidence and the results are the marginal distribution for individual variables, or the joint distribution over two or more variables or an overall model derived output such as the likelihood of evidence. Evidence refers to assigning a value to a variable. If the variable is a discrete variable, evidence sets the variable to one of its discrete values or if utilizing soft evidence, assigns a distribution over its discrete values. For a continuous variable, evidence assigns a value to that variable. A query over a PGM typically refers to setting evidence and requesting the posterior marginal of one or more variables that have not had evidence set. A query may also request a joint distribution or request an overall measure such as the likelihood of evidence. A query may also involve selecting a variable as a hypothesis variable and testing the influence on that variable of other model variables.

In a machine health management application, state detection often refers to detecting when behavior has departed from expected behavior. PGMs provide a powerful framework for state detection in IVHM. Following detection of an abnormal event a reasoning PGM can use the outputs of the PGM anomaly detector to isolate the cause. Further PGMs may provide prognostic assessment and decision support. A typical decision support scenario is making a decision to perform an inspection or test on the basis of a suspected failure or condition. Another scenario is deciding on appropriate maintenance action given a machine's state of health and operational role. Another type of use is for interactive troubleshooting where the process iterates with the model making suggestions and a human operator providing feedback. For decision modeling, a PGM may use two additional node types: a decision node that represents actions that may be taken and a utility node that represents the costs and benefits of those actions.

Some specific examples of IVHM functions with respect to PGMs may prove useful. Calculating residual values is a widely adopted method for assisting root cause analysis. The calculation involves predicting the expected value for a measurement using the values from other measurements. The expected value is then subtracted from the measured value to get the residual. Residuals provide a measure of deviation from expectation and, therefore, assist in identifying which measurements are not performing as expected. Virtual sensing is closely related to calculating residuals. The idea is to do away with or substitute a failed physical sensor by inferring its response using other sensor measurements. Both of the above tasks rely on the ability to model how one variable changes its behavior with other variables. All of these modeling methods may be generically classified as regression models. Such regression models may be mapped into a PGM with sufficient approximation to derive the required accuracy.

The approach used in building a PGM model or executing model inferencing can depend on the function of the model. For regression, in the supervised approach, the model variables may be split into input and output variables or predictor and predicted variables. The only variables or nodes that have evidence set are the input variables. And the output variables are those variables to be predicted. In the unsupervised approach, no distinction is made between input and output variables.

An example of an unsupervised model is the unconditional Gaussian Mixture Model that has a natural mapping into a PGM. A linear regression model has an equation of the form:

y=β₀+β₁x₁+β₂x₂+β₃x₁x₂+β₄x₁²+β₅x₂²+ε (1)

The predicted variable is y and the predictor variables are x1 and x2. The model parameters are β₀, β₁, β₂, β₃, β₄, and β₅. A noise term, ε, is also introduced to model error introduced by measurement error and other unknowns. The regression equation contains interaction and quadratic terms defined over the predictor variables.

FIG. 3 illustrates a PGM 30 having predictor variables 32 and a variable Y 34 for the following equation:

y=β₀+β₁x₁+β₂x₂+β₃x₃+β₄x₄+β₅x₅+ε (2)

It will be understood that the links between the predictor variables 32 implies an ordering of these predictor variables 32. No significance is attached to this ordering. That is, the order may change provided the parameters are adjusted accordingly. The PGM model 30 may contain many additional parameters to that conveyed in equation (2). This is because the PGM models the full covariance between all variables. These additional parameters are derived from the means and covariance of the predictor variables 32. The parameters in the variable Y 34 will correspond to the parameters in equation (2). Although the PGM contains additional parameters it allows a greater range of predictions to be performed. For example, y could be used as a predictor variable and x₃ the predicted variable, etc. The predictor variables may be de-correlated before modeling in the PGM in which case all predictor variables are independent and share no links.

If the regression model contains interaction or quadratic terms, etc., there will be additional variables in the PGM model representing each of these additional terms. For example, a PGM 40 for the equation:

y=β₀+β₁x₁+β₂x₁² (3)

may be modeled using the structure in FIG. 4 and may include predictor variable 42, variable Y 44, and quadric term 46.

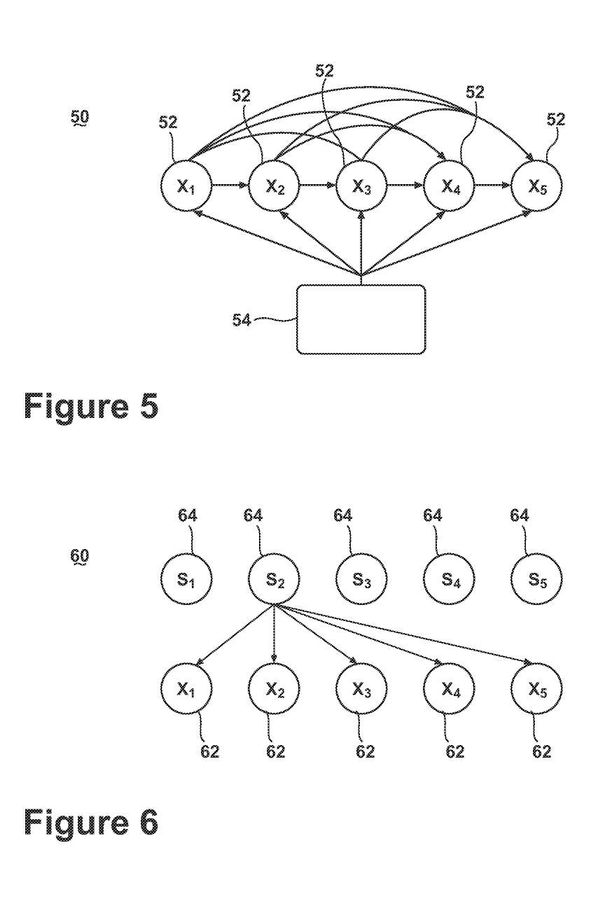

For some IVHM applications, prediction accuracy may be improved through using multiple regression models where the outputs from each model are mixed or where a specific regression model is selected from some input criteria. For example, a machine's behavior may vary depending on which mode or phase it is operating in. A regression model could be provided for each mode. A PGM 50 for modeling multiple regression models is shown in FIG. 5 and includes predictor variables 52 and components variable 54. The components variable 54 is a discrete variable with one state for each regression model. The PGM 50 may be used in a mixed mode where the outputs from multiple regressions are combined to produce the desired prediction.

Another type of data manipulation task is to de-correlate variables and/or to map the inputs onto a lower dimensional space. For example, if there is high correlation between variables, it might be possible to describe most of the data variance using a reduced set of variables. Principal Components Analysis (PCA) is a popular method for reducing or de-correlating the input space. An example PGM model 60 for PCA is shown in FIG. 6. Not all links are shown in this figure for clarity purposes and it may be understood that each X variable 62 is connected to each S variable 64. In this model, there are five X variables 62 denoted by Xi that are mapped onto five S variables 64 denoted by Si. The parameters for the PGM model 60 map directly onto those derived from PCA. Dimension reduction is achieved by controlling the number of S variables 64 which are ordered by decreasing component variance.

An embodiment of the method of the invention may be used for integrating the function models of the health management system and may include forming a database of at least some of the operation data, forming the structures for a plurality of PGMS for at least some of the health functions, mapping the structure of at least some of the PGMs to a mixture model learning task, learning at least some of the mixture models, using the learnt mixture models to provide the model parameters for each corresponding PGM, passing newly acquired operation data through the PGMs and making a determination of health status and potential actions.

Initially, it may be identified how at least some of the PGM models map to a mixture model structure. This may involve breaking down a model into sub-models where a sub-model is identified according to the value assigned by one or more discrete variables. Examples include but are not limited to: assigning a discrete variable to different failure modes with each value of the discrete variable representing a different mode; assigning a discrete variable to different operational states or phases (e.g. takeoff, cruise, approach, etc.); assigning a discrete variable to different fleets or routes; assigning a discrete variable to denote a period of time (e.g. breaking a signal into different phases or partitioning a calendar into different time periods); and assigning a discrete variable to denote different partitions of the input space (each measure variable is a dimension of the input space).

Forming the mixture model may include learning the mixture model from the database. In this manner, a mixture model learning module may be used to derive the parameters of the PGM variables. Such a mixture model learning module may be a separate module that is specialized for learning mixture models over continuous and discrete variables. This learning module may learn over large datasets and handle issues such as singularities, missing data, noisy data, etc., that arise with real world data. Further, this may decouple the learning from some of the model structure. For example, in many situations a discrete parent over a mixture of continuous variables may be redundant for learning the mixture distribution over the continuous variables. That is, the models relating to each value of the discrete parent(s) may be learnt separately, which may result in a more easily learnt model and quicker learning through parallelization. The mixture models may be learned using Expectation Maximization (EM). For some functions the PGM parameters may be derived efficiently using other methods including by way of non-limiting example standard PCA. Also for some model types, such as regression models, there may be reasons to use an algorithm other than mixture model learning to derive the parameter distributions.

Learning the mixture model may include selecting a subset of data from the database relevant to the health function to be learned. Each row in the database is called a case. A case could be an acquisition of data from different sensors or sensor derived features, etc. Each measured variable or derived feature will correspond to a column within the case. It is contemplated that in some instances a weight (a value between 0 and 1) may be assigned to each case according to the strength of association between the case and its vector of discrete variable values. For example, the symptoms for a fault may become more pronounced over time. If the data have been partitioned according to a fault variable, the cases can be weighted according to how prominent the symptoms are or according to how close in time the acquisition is to the point at which the fault is declared valid.

Learning the mixture model may also include assigning values for each of the discrete variables in the subset of data. The mixture model learning module may take as input a database of historical training data or already derived parameters for a model, a set of variables that include continuous variables and discrete variables, configuration parameters that are used for learning the mixture model, a list of constraints if any, and a parameter defining whether component removal is permitted and if so a quantity for removing. The discrete variables may be further divided into model learning variables, such as those that will take active part in deriving the mixture model, and conditional variables that are used to identify partitions in the training data. For each partition in the data there may be a unique mixture model. Thus, for many tasks there will be multiple mixture models that are derived.

Learning the mixture model may also include partitioning the subset of data according to the assigned values for the discrete variables. More specifically, the training data may be partitioned and data may be repeated across different partitions and assigned a weight defining the association of data to a partition. For example, if a first discrete variable has two values and a second discrete variable has three values there are six potential partitions of the data. A partition assigns data to a subset where a subset is labeled by the combination of values assigned to the discrete variables. There may be no data associated with a subset. The partitioning need not be a hard assignment of cases to different subsets. In other words, a case may be repeated in different subsets. This could arise, for example, where there is uncertainty as to whether a case is symptomatic of a failure so it may appear in the no fault subset with a low weighting and the fault subset with a higher weighting.

The mixture model learning module may take as input configuration parameters. Such configuration parameters may include a wide range of parameters, which may include but are not limited to: number of components, constraints on the covariance matrix, convergence tolerance to control when training terminates, priors, number of initial model builds, etc. The mixture model learning module may allow a minimum number of components and maximum number of components to be defined along with a step parameter. This allows the module to seek an optimum model by building multiple models that vary between the minimum and maximum components with the step defining how many additional components to add to the next model generated.

The mixture model learning module may take as input a list of constraints, if any. Such constraints may include but are not limited to, shared orientation or volume or shape of components between models. The constraints may not always be applied during model learning but are applied after learning.

During learning, the mixture model learning module may derive a mixture model for each partition of the data. The partitions may be determined according to the conditional variables. The mixture model learning module may derive statistics for the conditional variables for each model component.

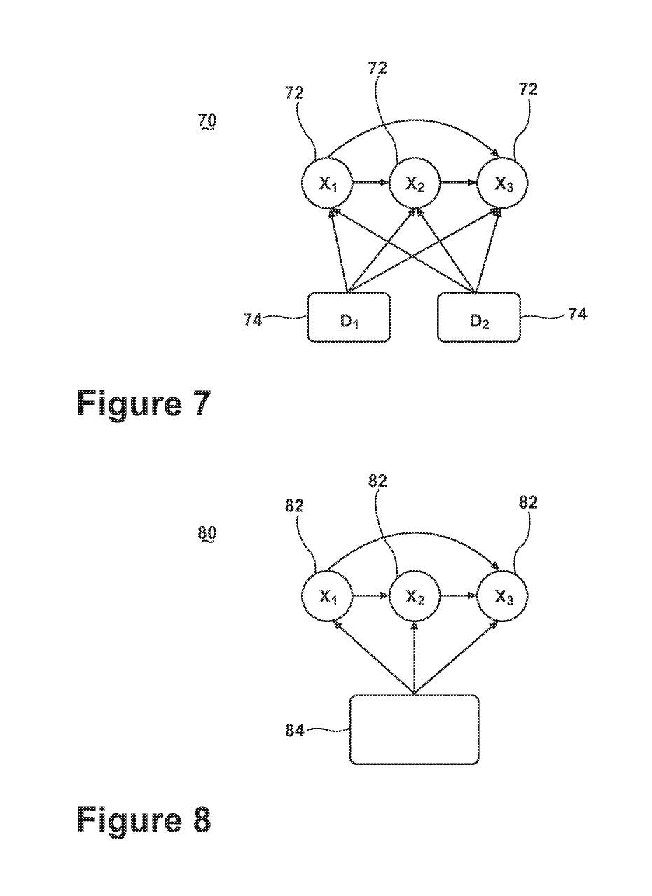

A PGM may then be generated from the mixture model for the at least some of the health functions. This may include mapping the mixture models from each subset into a PGM. The PGM may consist of variables, directed links between variables, and the parameters for each variable. There are a number of possible structures and the structure depends on the inference task and whether or not there is a model for each subset. If a model for each subset exists, and there is a single component per subset model, the PGM 70 FIG. 7 could be used and may include predictor variables 72 and discrete variables 74.

FIG. 8 illustrates a PGM 80, predictor variables 82, and components variable 84. When there are multiple components per subset model the component variable 84, which is discrete is introduced. The components in a subset model do not relate to components in other subset models. So the number of values in the components variable 84 is equal to the sum of the number of components in each subset model. So for three subsets with 2, 4, and 2 components the total number of components is 8. The values in the components variable 84 may be labeled appropriately to identify which model and component the value is associated with.

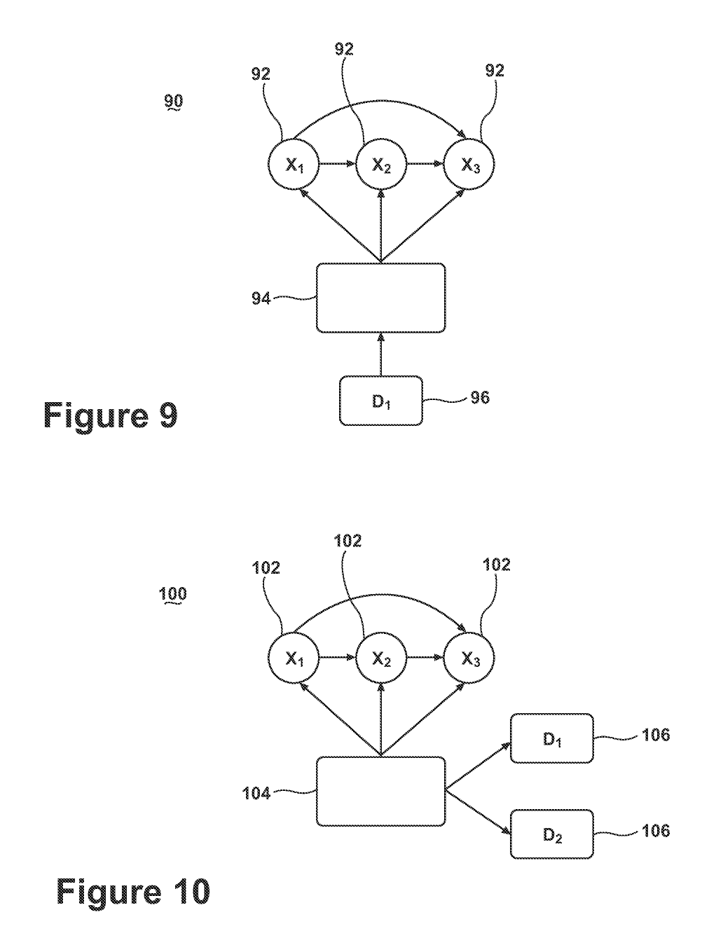

FIG. 9 illustrates a PGM 90 having predictor variables 92, a component variable 94, and a partition of the data according to a discrete variable or discrete parent 96 for which it is desired to set a prior distribution that is not conditional. In other words, this discrete parent 96 is required not to have a parent variable. An example is when modeling a failure mode where the variable is partitioned according to data that are representative of the failure and data that are not representative of the failure. The prior specifies the likelihood of the failure occurring.

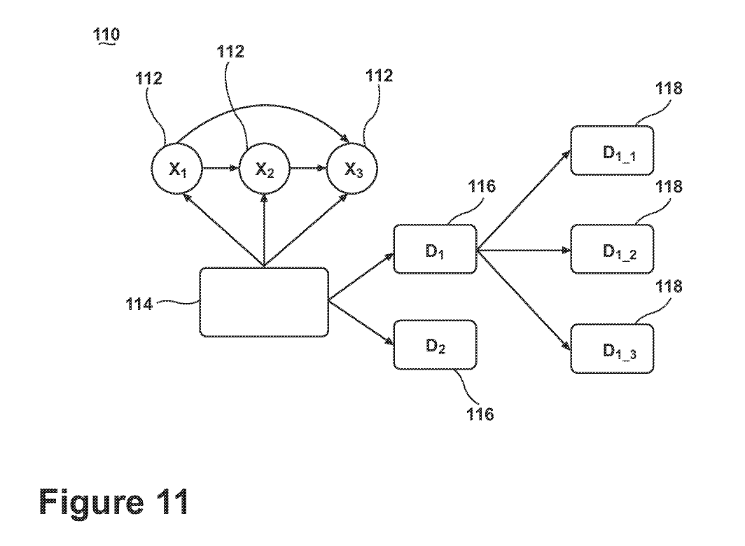

A PGM 100 is shown in FIG. 10 and includes predictor variables 102, components variable 104, and discrete variables 106, which may act as children of the components variable 104. This form of structuring allows the marginal for each value of a discrete variable to be calculated following evidence being set on the continuous variables. Alternatively, the discrete variables may be made to act as filters that will disable a model or components within a model during inference. If the partitioning generates subsets where each subset is a different machine, it is possible to get a view on a machine's health or performance from all the other machines by filtering out the model associated with the machine whose health is being determined. For example, FIG. 11 illustrates a PGM 110, which includes predictor variables 112, components variable 114, discrete variables 116, which may act as children of the components variable 114. Wherein filtering is facilitated when each discrete variable 116 has a binary child 118 for each of its values. The binary child 118 may have values True and False and evidence is set to false if the model components associated with that value are to be removed from the inference task.

It is contemplated that components for each mixture model may be learnt in isolation such that the mixing coefficients are not dependent on the conditional variables. This balances between the fidelity of modeling and simplifying a complex task to make the overall system manageable. The complexity of model structures is reduced and inference capability is maintained by integrating smaller and simpler structured models.

The above described embodiments provide a variety of benefits including that they map a range of functions that have traditionally been tackled with self-contained and isolated algorithms to a single theoretical framework. For many functions, this framework produces exactly the same outputs as the original implementations. The advantage of having functions within the same theoretical framework is that integration is far easier and helps maximize the retention of important information when data are passed between functions. Without this type of approach integration becomes more ad hoc and inevitably leads to loss of information because outputs from one function do not always map easily to another function. Further, the above described embodiments provide a standardized framework that gives the same representation formalism to a range of functions, which means that more sophisticated models may be constructed and the knowledge is encoded in one place. Essentially, the above embodiments allow for the IVHM to have enhanced capabilities as well as a simplified analytics integration architecture. This results in reducing time and effort to validate and reduces on-going maintenance costs.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for integrating function models of a health management system for a vehicle having multiple systems connected to a communications network and sending at least one of status messages and raw data regarding at least some operational data of the systems, the method comprising:
providing a plurality of health models, where each health model represents a health function of the vehicle, with at least some of the health models having parameters corresponding to at least some of the operation data;
executing the health models to generate health data related to the corresponding health function;
forming a database of the generated health data from the execution of the health models;
forming a mixture model from the database for at least some of the health functions;
generating a probabilistic graphical model (PGM) from the mixture model for the at least some of the health functions; and
making a determination of a health function based on the generated PGM.

2. The method of claim 1 wherein the forming the mixture model comprises learning the mixture model from the database.

3. The method of claim 2 wherein learning the mixture model comprises selecting a subset of data from the database relevant to the health function to be learned.

4. The method of claim 3 wherein learning the mixture model comprises assigning values for each discrete variable in the subset of data.

5. The method of claim 4 wherein learning the mixture model further comprises partitioning the subset of data according to the assigned values for the discrete variables.

6. The method of claim 4 wherein learning the mixture model comprises learning a mixture model for each partition.

7. The method of claim 4 wherein learning the mixture model further comprises selecting the continuous variables from the subset of data.

8. The method of claim 7 wherein learning the mixture model further comprises setting constraints between the continuous variables.

9. The method of claim 8 wherein learning the mixture model further comprises training the mixture model for the subset of data.

10. The method of claim 9 wherein generating the PGM comprises mapping the mixture model from the subset of data to the PGM.

11. The method of claim 1 wherein the mixture model is formed over continuous parameters and discrete parameters from the database that relate to the corresponding health function.

12. The method of claim 11 wherein the PGM is at least partially decoupled from a structure of the corresponding health module.

13. The method of claim 12 wherein the making the determination of the health function comprises at least one of diagnostic determination and a prognostic determination.
